(19) United States
(12) Patent Application Publication
(10) Pub. No.: US 2022/0335318 A1
(43) Pub. Date: Oct. 20, 2022

(54) DYNAMIC ANOMALY FORECASTING FROM EXECUTION LOGS

(71) Applicants: International Business Machines Corporation, Armonk, NY (US); Barcelona Supercomputing Center, Barcelona (ES)

(72) Inventors: Chen Wang, Chappaqua, NY (US); Alaa S. Youssef, Valhalla, NY (US); Josep Lluis Berral Garcia, Barcelona (ES)

(21) Appl. No.: 17/355,266

(22) Filed: Jun. 23, 2021

(30) Foreign Application Priority Data
Apr. 20, 2021 (EP) 21382339.6

(51) Int. Cl. G06N 7/00; G06F 11/00

(52) U.S. Cl. CPC G06N 7/005; G06F 11/006

(57) ABSTRACT

Techniques regarding anomaly forecasting are provided. For example, one or more embodiments described herein can comprise a system, which can comprise a memory that can store computer executable components. The system can also comprise a processor, operably coupled to the memory, and that can execute the computer executable components stored in the memory. The computer executable components can comprise a forecast component that can determine a probability of a computer application executing an anomaly state based on a probabilistic graph that is incrementally updated while the computer application is running.

### BACKGROUND

The subject disclosure relates to a self-evolving anomaly learner, and more specifically, to one or more anomaly learners that can autonomously generate resource execution graph patterns from log data aggregations.

Anomaly learners can detect one or more anomalies in a computer program. Traditional anomaly learners employ statistical, priority-based models that require supervised training to created models of standard program execution. The learner can then compare new program executions to the model and identify deviations, which are then correlated with one or more anomalies. To facilitate generation of the standard model and/or comparison with the new program executions, traditional anomaly learners consider log data in conjunction with other signals and/or performance metric data, such as telemetry and/or system call data.

However, traditional anomaly learners require predefined correct (e.g., standard) program behavior to enable the deviation detection. Additionally, traditional anomaly learners fail to consider a probability associated with an anomaly forecast (e.g., where an anomaly has not occurred, but has a probability of occurring in the future). Additionally, tradition anomaly detection techniques remain static, without the ability to evolve through dynamic software updating.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can forecast whether a running computer application will execute an anomaly state are described.

According to an embodiment, a system is provided. The system can comprise a memory that can store computer executable components. The system can also comprise a processor, operably coupled to the memory, and that executes the computer executable components stored in the memory. The computer executable components can comprise a forecast component that can determine a probability of a computer application executing an anomaly state based on a probabilistic graph that is incrementally updated while the computer application is running. An advantage of such a system can be the generation of an anomaly detection model absent supervised learning.

In some examples, the system can further comprise a mining component that can standardize log data via a log template. The log data can be comprised within a log file that describes a past execution performed by the computer application. Also, the mining component can further generate an event sequence that characterizes an order of events in the past execution. An advantage of such a system can be the generation of an anomaly detection model from log data that can be readily available with each execution of the computer application.

According to an embodiment, a computer-implemented method is provided. The computer-implemented method can comprise determining, by a system operatively coupled to a processor, a probability of a computer application executing an anomaly state based on a probabilistic graph that is incrementally updated while the computer application is running. An advantage of such a computer-implemented method can be the autonomous prediction of anomalies with associate probabilities that the anomalies will occur.

In some examples, the computer-implemented method can also comprise standardizing, by the system, log data via a log template. The log data can be comprised within a log file that describes a past execution performed by the computer application. The computer-implemented method can also comprise generating, by the system, an event sequence that characterizes an order of events in the past execution. Further, the probabilistic graph can be incrementally updated by mining additional log data from an additional log file that describes a more recent execution performed by the computer application than the past execution. An advantage of such a computer-implemented method can be an anomaly forecasting model that evolves based the most recent executions of the computer application.

According to an embodiment, a computer program product for dynamically forecasting an anomaly state on a computer application is provided. The computer program product can comprise a computer readable storage medium having program instructions embodied therewith. The program instructions can be executable by a processor to cause the processor to determine, by the processor, a probability of a computer application executing the anomaly state based on a probabilistic graph that is incrementally updated while the computer application is running. An advantage of such a computer program product can be the generation of a probabilistic graph that models both desired and undesirable behavior for anomaly detection.

In some examples, the program instructions can further cause the processor to map, by the processor, a current state of the computer application to a position on the probabilistic graph. Also, the program instructions can cause the processor to forecast, by the processor, whether the computer application will execute the anomaly state by aggregating the probabilities associated with a set of transitions between the position of the computer application on the probabilistic graph and a position of the anomaly state on the probabilistic graph. An advantage of such a computer program product can be the enablement of an anomaly detection technique that adjusts based on the current state of the computer application.

### BRIEF DESCRIPTION OF THE DRAWINGS

FIG. 1 illustrates a block diagram of an example, non-limiting system that can determine a probability of a computer application executing an anomaly state based on a probabilistic graph model that can be incrementally updated while the computer application is running in accordance with one or more embodiments described herein.

FIG. 2 illustrates a diagram of an example, non-limiting log mining template that can be employed to generate one or more probabilistic graph models in accordance with one or more embodiments described herein.

FIG. 3 illustrates a diagram of an example, non-limiting log mining operation that can generate one or more event sequences described within one or more log files of a computer application in accordance with one or more embodiments described herein.

FIG. 4 illustrates a diagram of an example, non-limiting log mining operation that can generate one or more event sequences described within one or more log files of a computer application in accordance with one or more embodiments described herein.

FIG. 5 illustrates a block diagram of an example, non-limiting system that can generate one or more probabilistic graphs that can model the likelihood of a computer application transitioning from one state to another based on one or more data log entries in accordance with one or more embodiments described herein.

FIG. 6 illustrates an example, non-limiting probabilistic graph that can model one or more event sequences characterized by one or more data logs of a computer application in accordance with one or more embodiments described herein.

FIG. 7 illustrates an example, non-limiting probabilistic graph that can model one or more event sequences characterized by one or more data logs of a computer application in accordance with one or more embodiments described herein.

FIG. 8 illustrates an example, non-limiting diagram demonstrating a variety of probabilistic graph types that can be employed by a system to model one or more data logs of a computer application in accordance with one or more embodiments described herein.

FIG. 9 illustrates a block diagram of an example, non-limiting system that can determine a probability of a computer application achieving an end event based on one or more event sequences that characterize data logs achieved by past executions of the computer application in accordance with one or more embodiments described herein.

FIG. 10 illustrates a block diagram of an example, non-limiting system that can detect the current position of a computer application along one or more model event sequences to forecast whether the computer application will achieve an anomaly state in accordance with one or more embodiments described herein.

FIGS. 11A-11B illustrates diagrams of an example, non-limiting probability determinations that can characterize the likelihood of an end event in relation to one or more prior event transitions in accordance with one or more embodiments described herein.

FIG. 12 illustrates a diagram of an example, non-limiting forecasting procedure that can be employed by an autonomous system to determine a probability of a computer application executing an anomaly state based on a probabilistic graph model that can be incrementally updated while the computer application is running in accordance with one or more embodiments described herein.

FIG. 13 illustrates a flow diagram of an example, non-limiting computer-implemented method that can forecast the likelihood that a computer application will achieve an anomaly state based on one or more execution logs previous achieved by the computer application in accordance with one or more embodiments described herein.

FIG. 14 illustrates a flow diagram of an example, non-limiting computer-implemented method that can forecast the likelihood that a computer application will achieve an anomaly state based on one or more execution logs previous achieved by the computer application in accordance with one or more embodiments described herein.

FIG. 15 depicts a cloud computing environment in accordance with one or more embodiments described herein.

FIG. 16 depicts abstraction model layers in accordance with one or more embodiments described herein.

FIG. 17 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given the problems with other implementations of traditional anomaly detection techniques; the present disclosure can be implemented to produce a solution to one or more of these problems by forecasting anomalies based on historic execution logs of one or more computer applications. Advantageously, one or more embodiments described herein can include an evolving anomaly forecasting mechanism that can dynamically forecast low-chance states on running computer application in an unsupervised way.

Various embodiments of the present invention can be directed to computer processing systems, computer-implemented methods, apparatus and/or computer program products that facilitate the efficient, effective, and autonomous (e.g., without direct human guidance) dynamic anomaly forecasting. For example, one or more embodiments described herein can generate one or more probabilistic graphs to model event sequences executed by a computer application and described in one or more execution logs. In various embodiments, the one or more probabilistic graphs can be updated incrementally as the computer application is running. Thereby, the one or more probabilistic graphs can be updated as new execution logs become accessible. Additionally, one or more embodiments can employ the probabilistic graph models to predict anomaly future states of the computer application and/or determine likelihoods associated with the predictions.

The computer processing systems, computer-implemented methods, apparatus and/or computer program products employ hardware and/or software to solve problems that are highly technical in nature (e.g., dynamically forecasting anomaly future states of a computer application), that are not abstract and cannot be performed as a set of mental acts by a human. For example, an individual, or a plurality of individuals, cannot incrementally update probabilistic models characterizing computer application event sequences as the application is running to forecast anomaly states in accordance with one or more embodiments described herein.

Also, one or more embodiments described herein can constitute a technical improvement over conventional anomaly detection techniques by forecasting future states of a running computer application based on the current state of the computer application. Additionally, various embodiments described herein can demonstrate a technical improvement over conventional anomaly detection techniques by employing probabilistic graph models to forecast anomalies in an unsupervised approach, which can be incrementally updated as the computer application is running. For example, various embodiments described herein can incrementally update probabilistic graph models characterizing event sequences likely to be experienced by the computer application based on new execution logs that can be received via one or more cloud computing environments.

Further, one or more embodiments described herein can have a practical application by determining the likelihood that a forecasted anomaly will occur based on historic execution logs and/or the current state of a running computer application. For instance, various embodiments described herein can analyze past event sequences described by execution logs of one or more computer applications to aggregate a probability that a running computer application will transition to predicted end state in accordance with the past event sequences.

As used herein, the term “an anomaly state”, and/or grammatical variants thereof, can refer to a computer application state that achieves an alternative to one or more desired states. For instance, an anomaly state can be achieved when a computer application: achieves a rare result, execution, and/or transition (e.g., as compared to standard operations of the computer application); fails to achieve a desired end state (e.g., fails to start and/or complete a job tasked to the computer application); and/or engages in one or more executions and/or execution sequences that are detrimental to the efficacy of the computer application (e.g., engage in one or more execution loops that inhibit progression to the desired end state, such as execution loops that inhibit completion of a job tasked to the computer application). In various embodiments, anomaly states can include, for example, point anomalies, contextual anomalies, and/or collective anomalies.

In various embodiments, an anomaly state can include a state in which the computer application experiences a failure or problematic execution scenario. For instance, the computer application can be considered to achieve an anomaly state when the computer application is unable to complete a job and/or function as intended. In one or more embodiments, achieving an anomaly state can be characterized by one or more key words within the execution logs (e.g., of the given computer application and/or another computer application). Example key words indicative of an anomaly state can include, but are not limited to: “failed to schedule”, “insufficient resources to start a job”, “job pending” “job failed”, “job canceled”, “transaction canceled”, “pod pending”, “failed to schedule a pod”, a combination thereof, and/or the like. Likewise, achieving a desired state by the computer application can also be characterized by one or more key words within the execution logs. Example key words indicative of a desired state can include, but are not limited to: “job finished”, “transaction finished”, “resource ready”, “pod complete”, a combination thereof, and/or the like.

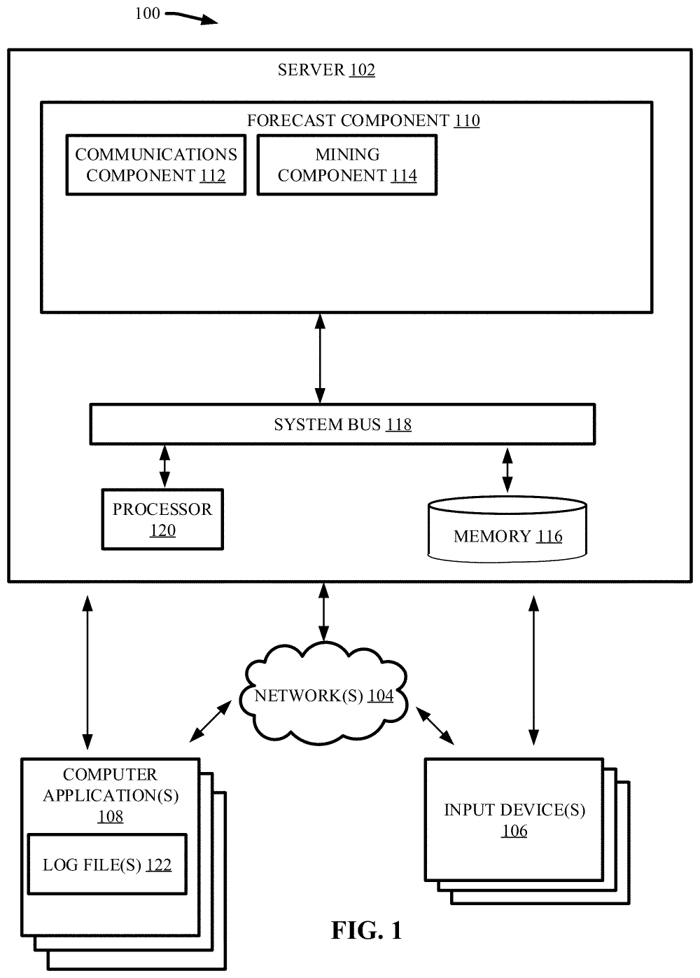

FIG. 1 illustrates a block diagram of an example, non-limiting system 100 that can dynamically forecast whether a running computer application is likely to achieve an anomaly state based on an evolving, unsupervised probabilistic graph analysis. Repetitive description of like elements employed in other embodiments described herein is omitted for sake of brevity. Aspects of systems (e.g., system 100 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines (e.g., computers, computing devices, virtual machines, a combination thereof, and/or the like) can cause the machines to perform the operations described.

As shown in FIG. 1, the system 100 can comprise one or more servers 102, one or more networks 104, input devices 106, and/or computer applications 108. The server 102 can comprise forecast component 110. The forecast component 110 can further comprise communication component 112 and/or mining component 114. Also, the server 102 can comprise or otherwise be associated with at least one memory 116. The server 102 can further comprise a system bus 118 that can couple to various components such as, but not limited to, the forecast component 110 and associated components, memory 116 and/or a processor 120. While a server 102 is illustrated in FIG. 1, in other embodiments, multiple devices of various types can be associated with or comprise the features shown in FIG. 1. Further, the server 102 can communicate with one or more cloud computing environments.

The one or more networks 104 can comprise wired and wireless networks, including, but not limited to, a cellular network, a wide area network (WAN) (e.g., the Internet) or a local area network (LAN). For example, the server 102 can communicate with the one or more input devices 106 and/or computer applications 108 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the forecast component 110 can be provided on the one or more servers 102, it should be appreciated that the architecture of system 100 is not so limited. For example, the forecast component 110, or one or more components of forecast component 110, can be located at another computer device, such as another server device, a client device, and/or the like.

The one or more input devices 106 can comprise one or more computerized devices, which can include, but are not limited to: personal computers, desktop computers, laptop computers, cellular telephones (e.g., smart phones), computerized tablets (e.g., comprising a processor), smart watches, keyboards, touch screens, mice, a combination thereof, and/or the like. The one or more input devices 106 can be employed to enter one or more anomaly detection preferences into the system 100, thereby sharing (e.g., via a direct connection and/or via the one or more networks 104) said data with the server 102. For example, the one or more input devices 106 can send data to the communication component 112 (e.g., via a direct connection and/or via the one or more networks 104). Additionally, the one or more input devices 106 can comprise one or more displays that can present one or more outputs generated by the system 100 to a user. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

In various embodiments, the one or more input devices 106 and/or the one or more networks 104 can be employed to input one or more settings and/or commands into the system 100. For example, in the various embodiments described herein, the one or more input devices 106 can be employed to operate and/or manipulate the server 102 and/or associate components. Additionally, the one or more input devices 106 can be employed to display one or more outputs (e.g., displays, data, visualizations, and/or the like) generated by the server 102 and/or associate components. Further, in one or more embodiments, the one or more input devices 106 can be comprised within, and/or operably coupled to, a cloud computing environment.

In various embodiments, the one or more computer applications 108 can be run on one or more computers and/or cloud computing environments. The one or more computer applications 108 can be, for example, large scale distributed applications for executing jobs, or managing computer resources, that have a life cycle. Example computer applications 108 can include, but are not limited to: Kubernetes applications, OpenStack applications, Spark applications, Hadoop applications, KubeFlow applications, FfDL applications, and/or the like. In one or more embodiments, the one or more computer applications 108 can be run interactively (e.g., via the one or more input devices 106) and/or autonomously. Further, the one or more computer applications 108 can be run automatically, on a schedule, and/or by manual operation. In various embodiments, past and current states of the computer application 108 can be analyzed by the forecast component 110 while the computer application 108 is running to predict a future state of the running computer application 108.

For example, the one or more computer applications 108 can generate, update, and/or maintain one or more log files 122. The one or more log files 122 can record executions performed by the one or more computer applications 108 by describing events, transitions, and/or states of a computer application 108 during operation. In various embodiments, the one or more log files 122 can include, for example, one or more event logs, transaction logs, system logging protocols (“syslogs”), server logs, audit logs, daemon logs, pods, swift logs, message logs, cloud platform logs, cluster management logs, container logs, a combination thereof, and/or the like. For example, the one or more log files 122 can comprise entries that include, but are not limited to: log entries related to each resource employed by, and/or job executed by, the one or more computer applications 108; unique identifiers associated with each resource and/or job; timestamps associated with each log entry; resource type descriptions employed by the one or more computer applications 108; a combination thereof, and/or the like. For instance, log data of the one or more log files 122 can include unique identifiers that associates the given log data with a particular job execution and/or resource management. In another instance, where the log file 122 describes records operation of a computer application 108 that can employ multiple types of computer resources (e.g., a Kubernetes computer application 108), the log data can delineate the type of computer resource employed in the given job execution and/or resource management. In various embodiments, the one or more log files 122 can include log data regard various components and/or sub-applications of the one or more computer applications 108.

In various embodiments, the one or more log files 122 can define the end states achieved by the one or more computer applications 108 when executing a job and/or managing a resource. Additionally, the one or more log files 122 can define one or more events and/or transitions that occurred in achieving the end state. In one or more embodiments, the one or more computer applications 108 can have a desired end state associated with each job and/or resource managed by the one or more computer applications 108. The one or more computer applications 108 can populate the one or more log files 122 with log entries describing each execution performed; thereby, the one or more log files 122 can describe executions that achieved desired end states and executions that achieved anomaly states.

In one or more embodiments, the one or more computer applications 108 can share (e.g., stream) the one or more log files 122 with the forecast component 110 as the log files 122 are generated and/or updated. For example, the one or more computer applications 108 can send the one or more log files 122 to the communication component 112 via a direct electrical connection and/or the one or more networks 104 in response to a new log entry being added to the one or more log files 122. The communication component 112 can receive the one or more log files 122 and share the data of the one or more log files 122 with the associate components of the forecast component 110 (e.g., can share the one or more log files 122 with the mining component 114). In one or more embodiments, the communication component 112 can further store the one or more log files 122 in the memory 116 for subsequent review and/or analysis by the associate components of the forecast component 110.

In various embodiments, the mining component 114 can collect and assemble log entries from the one or more log files 122 to generate one or more log mining templates using one or more log template mining techniques (e.g., including classification techniques, regression techniques, and/or clustering techniques). For example, the mining component 114 can collect log data from the log files 122. As described herein, the log files 122 can include data from various types of sources (e.g., syslogs, server logs, audit logs, message logs, transaction logs, and/or the like). The log data collected by the mining component 114 can include log entries from each of the sources.

Further, the mining component 114 can aggregate the log data by employing one or more log collector tools. In various embodiments, the mining component 114 can also clean the aggregated log data via one or more data cleaning techniques. For example, the one or more data cleaning techniques can remove corrupted data, redundant data, and/or duplicate data. The mining component 114 can then structure the cleaned, aggregated log data into one or more templates. In various embodiments, the mining component 114 can structure the log data from the one or more log files 122 into one or more templates to establish a uniform structure to the log data; thereby facilitating the generation of one or more probabilistic graph models that can be employed to forecast anomaly states. Further, the mining component 114 can describe the sequence of events described in the log files 122 using the uniform structure of the templates. For example, each job execution and/or resource management operation by a computer application can be described in the one or more log files 122 via an associate sequence of events. The mining component 114 can restructure the log data based on the log templates to reflect a uniformed structure and generate sequences of the structured data that reflect the sequence of events experienced by the computer application 108, as described by the log files 122.

In various embodiments, the one or more computer applications 108 can stream new log data to the forecast component 110 while the one or more computer applications 108 are running. The mining component 114 can thereby collect, aggregate, and clean the new log data and correlate the new log data into one or more existing templates or generate a new template based on the new log data. Thereby, the log data modeled by the forecast component 110 can evolve through incremental updates that incorporate real time, or near real time, data characterizing the performance of one or more running computer applications 108.

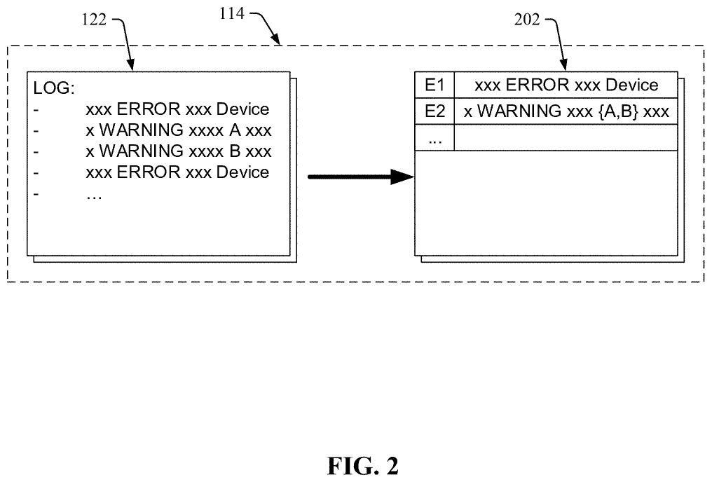

FIG. 2 illustrates a diagram of an example, non-limiting log mining template 202 that can be generated by the mining component 114 in accordance with one or more embodiments described herein. Repetitive description of like elements employed in other embodiments described herein is omitted for sake of brevity. As shown in FIG. 2, the mining component 114 can analyze the one or more log files 122 and generate one or more log mining templates 202.

For example, specific events described in the log files 122 can be correlated to general category structures within the log mining templates 202. For instance, in the exemplary log mining template 202 shown in FIG. 2, error events of the same type can be correlated to the same category (e.g., correlated to event E1). In another instance, in the exemplary log mining template 202 shown in FIG. 2, warning events of the same type (even if propagated with regards to different components of the computer application 108) can be correlated to the same category (e.g., correlated to event E2). While FIG. 2 depicts the log mining templates 202 having a table structure, the architecture of the log mining templates 202 is not so limited. For example, embodiments in which the log mining templates 202 employ different structures (e.g., a list structure) and/or nomenclatures (e.g., correlating events described in the log files 122 to labelled transitions in the log mining template 202) are also envisaged.

Where the forecast component 110 is being initialized and/or trained on a computer application 108, the mining component 114 can analyze the log files 122 and generate initial log mining templates 202. As the computer application 108 performs new executions and thereby updates the log files 122 with new log data, the mining component 144 can compare the new log data to existing log mining templates 202. Where the new log data is already characterized by a category in the existing log mining templates 202, the mining component 114 can match the new log data to the existing log mining template 202 of relevancy. Where the new log data is not characterized by a category in the existing log mining templates 202, the mining component 114 can update the log mining templates 202 (e.g., by creating a new category based on the new log data). Thus, the mining component 114 can evolve the log mining templates 202 over time as new execution events are experienced by the computer applications 108 and recorded in the log files 122.

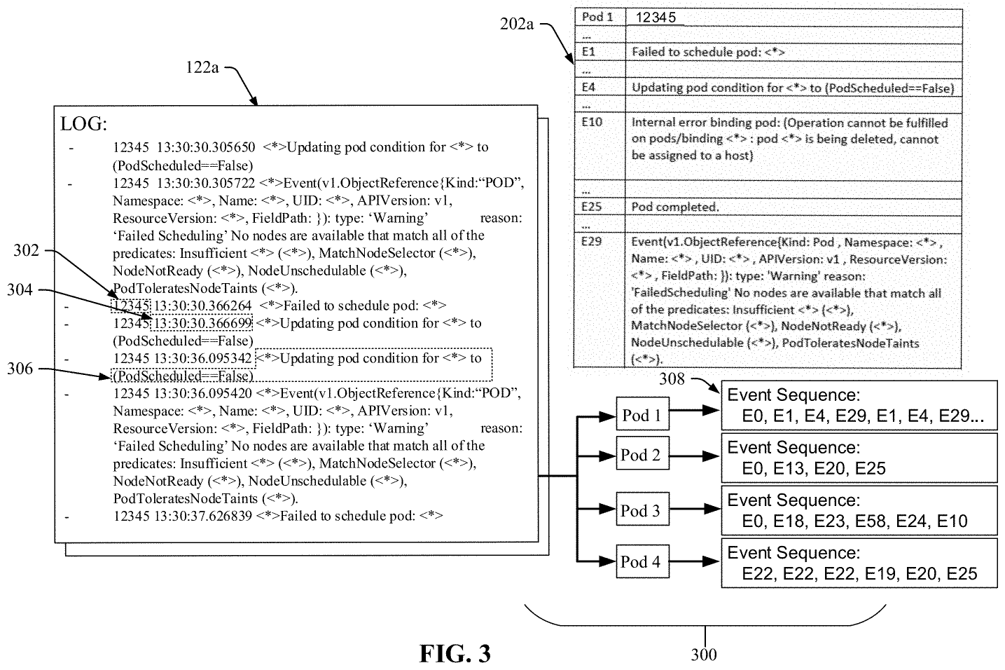

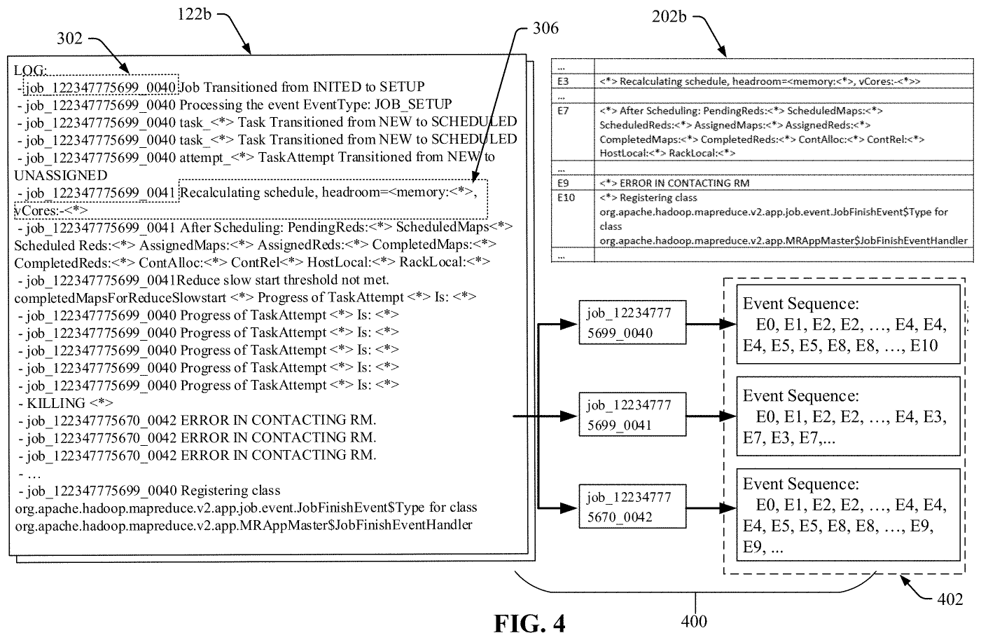

FIGS. 3-4 illustrate diagrams of example, non-limiting log mining operations that can be performed by the mining component 114 in accordance with one or more embodiments described herein. Repetitive description of like elements employed in other embodiments described herein is omitted for sake of brevity. FIG. 3 illustrates a first example log mining operation 300 in which the mining component 114 can extract log data associated with a Kubernetes computer application 108. FIG. 4 illustrates a second example log mining operation 400 in which the mining component 114 can extract log data associated with a Hadoop computer application 108.

As shown in FIG. 3, the mining component 114 can extract log data from a first exemplary log file 122a. The first exemplary log file 122a can include log data pertaining to a computer resource (e.g., a pod) managed by the computer application 108. For instance, each entry of the first exemplary log file 122a can include an identifier 302 (e.g., an identification code) associated with a respective computer resource and/or job. In FIG. 3, the log data of the first exemplary log file 122a is labeled with the identifier 302 “12345”. In various embodiments, log files 122 can include log data regarding a plurality of resources and/or jobs, each associated with a respective identifier 302. For example, the one or more log files 122 can include log data from various components and/or sub-applications of the computer application 108. For instance, the first exemplary log file 122a regards a Kubernetes computer application 108 and can include log data from a scheduler, a node manager, and/or one or more other controllers. Also, each entry of the log file 122 can further include a timestamp 304. In FIG. 3, “<*>” is used as a placeholder for text that can vary from log entry to log entry depending on the resource managed and/or the job executed.

In addition to the identifier 302 and timestamp 304, each entry can describe the occurrence of an event 306 experienced during execution of the computer application 108 (e.g., in association with the identified resource and/or job and at the delineated time). Example events 306 can include, but are not limited to: an action and/or transition performed by the computer application 108, a status of the computer application 108, a condition of the computer application 108, a state of the computer application 108, a combination thereof, and/or the like. One of ordinary skill in the art will recognize that a vast variety of events 306 can be described by the log data.

FIG. 3 also shows at least a portion of a first exemplary log mining template 202a that can be generated by the mining component 114 in accordance with the various embodiments described herein. The mining component 114 can match the events 306 described in the log file 122 to a log mining template 202 and/or generate a new log mining template 202 to account for one or more new events 306 not previously experienced in past executions. For example, the mining component 114 can compare the events 306 described in the first exemplary log file 122a to the first exemplary log mining template 202a (e.g., which can be generated based on the first exemplary log file 122a and/or can be previously generated from a previous analysis of log files 122) and identify the occurrence of events E1, E4, and/or E29. Further, the mining component 114 can generate an event sequence associated with the job and/or resource to describe the transition from one event to another, as delineated by the log file 122. For instance, the first exemplary log file 122a can include a repeating loop of events E1, E4, and/or E29. The mining component 114 can generate first exemplary event sequence 308 based on the chronological order of the events 306 to delineate the transitions from event E1 to event E4 to event E29 included in the first exemplary log file 122a.

For ease of clarity, FIG. 3 illustrates portions of the first exemplary log file 122a and/or log mining template 202a pertaining to the generation of the first example event sequence 308. However, as shown in FIG. 3, the first exemplary log files 122a can include additional log data describing other computer resources (e.g., regarding “Pod 2”, “Pod 3”, and/or “Pod 4”) and/or respective event sequences. The mining component 114 can compare the additional log data to the totality of the first exemplary log mining template 202a (e.g., not shown) to structure the log data and generate the additional example event sequences shown in FIG. 3.

As shown in FIG. 4, the mining component 114 can extract log data from a second exemplary log file 122b. The second exemplary log file 122b can include log data pertaining to one or more jobs executed by the computer application 108. For instance, each entry of the second exemplary log file 122b can include an identifier 302 (e.g., an identification code) associated with a respective computer resource and/or job. In FIG. 4, the displayed portion of the second exemplary log file 122b includes the job identifiers 302 “job_122347775699_0040”, “job_12347775699_0041”, and “job_12347775670_0042”. In various embodiments, log files 122 can include log data regarding a plurality of resources and/or jobs, each associated with a respective identifier 302. For example, the one or more log files 122 can include log data from various components and/or sub-applications of the computer application 108. For instance, the second exemplary log file 122b regards a Hadoop computer application 108 and can include log data regarding a plurality of executed jobs. In FIG. 4, “<*>” is used as a placeholder for text that can vary from log entry to log entry depending on the resource managed and/or the job executed.

The log data of the second exemplary log file 122b can describe the occurrence of events 306 experienced during execution of the computer application 108 (e.g., in association with the identified resource. FIG. 4 also shows at least a portion of a second exemplary log mining template 202b that can be generated by the mining component 114 in accordance with the various embodiments described herein. For example, the mining component 114 can compare the events 306 described in the second exemplary log file 122b to the second exemplary log mining template 202b (e.g., which can be generated based on the second exemplary log file 122a and/or can be previously generated from a previous analysis of log files 122) and identify the occurrence of events E1, E4, and/or E29. Further, the mining component 114 can generate an event sequence associated with the job and/or resource to describe the transition from one event to another, as delineated by the log file 122. For instance, the first exemplary log file 122a can include a repeating loop of events E3, E7, E9 and/or E10. The mining component 114 can generate example event sequences shown in FIG. 4 based on the chronological order of the events 306 to delineate the transitions from one event to another. In various embodiments, where the log data is not timestamped, the chronological order of the event sequence can be determined by the mining component 114 in accordance with the event 306 order of appearance within the one or more log files 122.

For ease of clarity, FIG. 4 illustrates portions of the second exemplary log file 122b and/or second exemplary log mining template 202b. However, the second exemplary log files 122b can include additional log data describing, for example, additional events 306 associated with the one or more executed jobs. The mining component 114 can compare the additional log data to the totality of the second exemplary log mining template 202b (e.g., not shown) to structure the log data and generate the example event sequences 402 shown in FIG. 4.

In various embodiments, as the computer applications 108 are running, and thereby generating new log data, the mining component 114 can further update the one or more generated event sequences in addition to updating the one or more log mining templates 202. For example, the new log data can be included in one or more new log files 122 analyzed by the mining component 114, which can compare the order of events 306 described by the new log data with existing event sequences previously generated by the mining component 114 based on past log data. Where the order of events 306 described by the new log data is already characterized by one or more existing event sequences, the mining component 114 need not generate a new event sequence. Where the order of events 306 described by the new log data is not yet characterized by one or more of the existing event sequences, the mining component 114 can generate a new event sequence to capture the newly recorded order of operations.

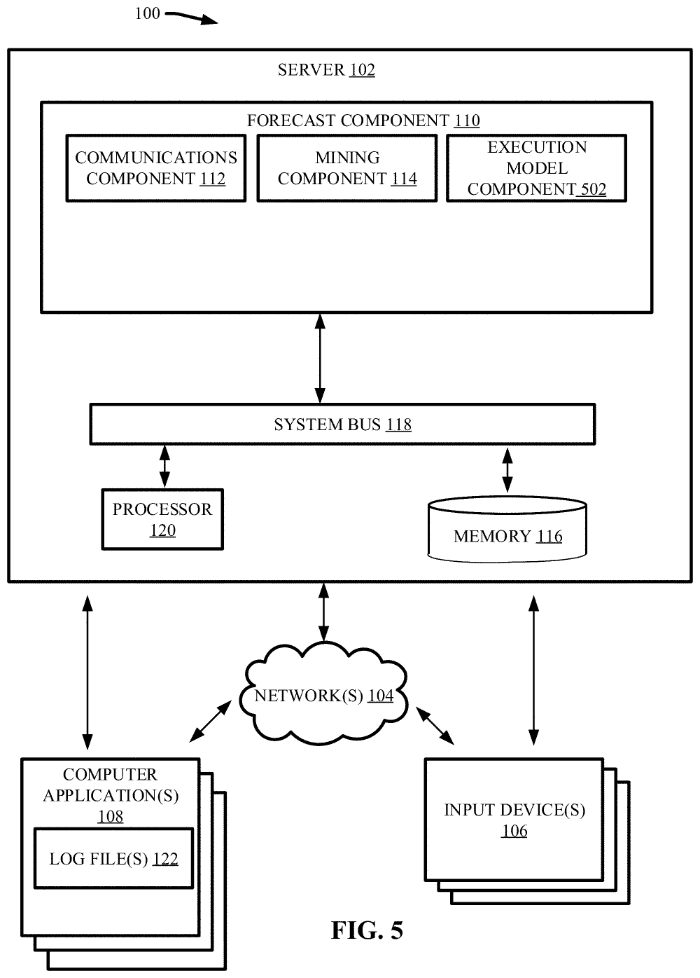

FIG. 5 illustrates a diagram of the example, non-limiting system 100 further comprising execution model component 502 in accordance with one or more embodiments described herein. Repetitive description of like elements employed in other embodiments described herein is omitted for sake of brevity. In various embodiments, the execution model component 502 can generate one or more graphs modeling the event sequences (e.g., exemplified by first example event sequence 308 shown in FIG. 3 and/or example event sequences 402 shown in FIG. 4) generated by the mining component 114. For example, one or more execution graphs generated by the execution model component 502 can be probabilistic graphs based on the event sequences that can include transitions between events, as described in the log data of the one or more log files 122. Thereby, the one or more execution graphs can model event sequences experienced by one or more computer applications 108 while executing a job and/or managing a resource.

In various embodiments, execution model component 502 can aggregate multiple event sequences generated by the mining component 114 into an execution graph that models historic operation of the one or more computer applications 108 (e.g., as recorded in the one or more log files 122). For example, multiple event sequences can be combined into a single execution graph via one or more aggregation techniques, such as clustering. For instance, an execution graph generated by the execution model component 502 can model a plurality of event sequences and/or can describe how the event sequences can relate to each other via shared events 306. Example graph structures that can be employed by the execution model component 502 to generate the one or more execution graphs can include, but are not limited to: tree structures, Markov chain structures, a probabilistic tree, Bayesian network, and Markov Random fields, a combination thereof, and/or the like.

In one or more embodiments, the one or more execution graphs can be structured as tree graphs with one or more branches extending from an initial state and/or from other branches. The ends of the branches can represent end states experienced by the one or more computer applications 108, and the composition of the branches can represent the event transitions and/or event order defined by the one or more event sequences generated by the mining component 114.

Additionally, in response to the mining component 114 generating one or more new event sequences to characterize new log data of a running computer application 108, the execution model component 502 can update one or more execution graphs to model the new event sequences. For example, an existing execution graph generated by the execution model component 502 can be altered (e.g., by adding one or more branches, convergences, and/or divergences) to further model the newly generated event sequences.

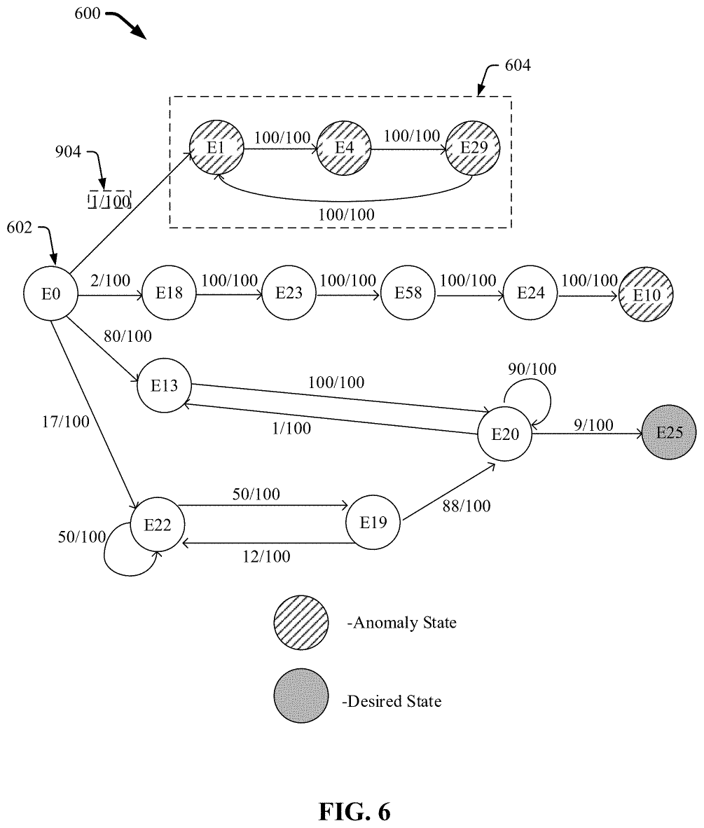

FIG. 6 illustrates an example, non-limiting first exemplary execution graph 600 that can be generated by the execution model component 502 in accordance with one or more embodiments described herein. Repetitive description of like elements employed in other embodiments described herein is omitted for sake of brevity. The first exemplary execution graph 600 can model the example event sequences depicted in FIG. 3 (e.g., including first exemplary event sequence 308). For example, the first exemplary execution graph 600 can aggregate the plurality of example event sequences depicted in FIG. 3 into a single model.

As shown in FIG. 6, the one or more execution graphs generated by the execution model component 502 can include a plurality of interconnected nodes 602. Each node 602 can represent a category from the one or more log mining templates 202 generated by the mining component 114. For example, the nodes 602 can represent event categorizations (e.g., represented by “EN”, where “N” is an integer) from the one or more log mining templates 202 (e.g., as shown in FIG. 6). For instance, the nodes 602 can represent an event 306 described in the one or more log files 122 and/or formatted in accordance with the one or more log mining templates 202.

For example, the first exemplary execution graph 600 is structured as a tree graph with the topmost branch modeling the first exemplary event sequence 308 shown in FIG. 3. As shown in FIG. 3, the first exemplary event sequence 308 defines a sequence of events 306 described in the first exemplary file log 122a; where a first event 306 correlating with category E1 of the first exemplary log mining template 202a is followed by a second event 306 correlating with category E4 of the first exemplary log mining template 202a and followed thereafter by a third event 306 correlating with category E29 of first exemplary log mining template 202a. Further, the first exemplary event sequence 308 delineates that the transition from E1 to E4 to E29 continues to repeat itself. Likewise, the topmost branch of the first exemplary execution graph 600 models the first exemplary event sequence 308 via a node 602 for each of E1, E4, E29 and directional connections defining the progression from the node 602 for E1 to the node 602 for E4 to the node 602 for E29 and back to the node 602 for E1.

Further, the execution model component 502 can define the end states modeled by the execution graphs as anomaly states or desired states of the computer application 108. For example, in the first exemplary execution graph 600, end states achieved by the computer application 108 that correspond to anomaly states are marked by cross-hatched nodes 602, while end states corresponding to desired states are marked by grey nodes 602. For instance, loop 604 (e.g., recorded in the first exemplary log file 122a, defined in the first exemplary event sequence 308, and modeled in the first exemplary execution graph 600) can be defined by the execution model component 502 as an anomaly state at least because it represents a continuous repetition of events 306 that result in a failure to complete the desired function the computer application 108 (e.g., fail to complete a job).

As shown in FIG. 6, additional branches of the first exemplary execution graph 600 can further model example event sequences depicted in FIG. 3. For instance, the next branch under the topmost branch can model the third event sequence shown in FIG. 3. Additionally, the execution model component 502 can delineate that the next branch under the topmost branch of the first exemplary execution graph 600 ends in an anomaly state. For example, the event sequence modeled by the branch can end in E10, which can correlate to an error event 306 that causes the computer application 108 to fail to execute the assigned job and/or resource management.

Further, one or more branches of the execution graphs can converge and/or diverge to model the event sequences. For example, two or more branches of the execution graphs can converge to model event sequences that share event transitions. For instance, the two bottommost branches of the first exemplary execution graph 600 can converge on the node 602 representing E20 to model a transition from E20 to E25 that is included in two of the example event sequences shown in FIG. 3. Additionally, the execution model component 502 can delineate that the bottom two branches of the first exemplary execution graph 600 can end in a desirable state. For example, the event sequences modeled by the two bottom branches can end in E25, which can correlate to a completed job and/or resource management.

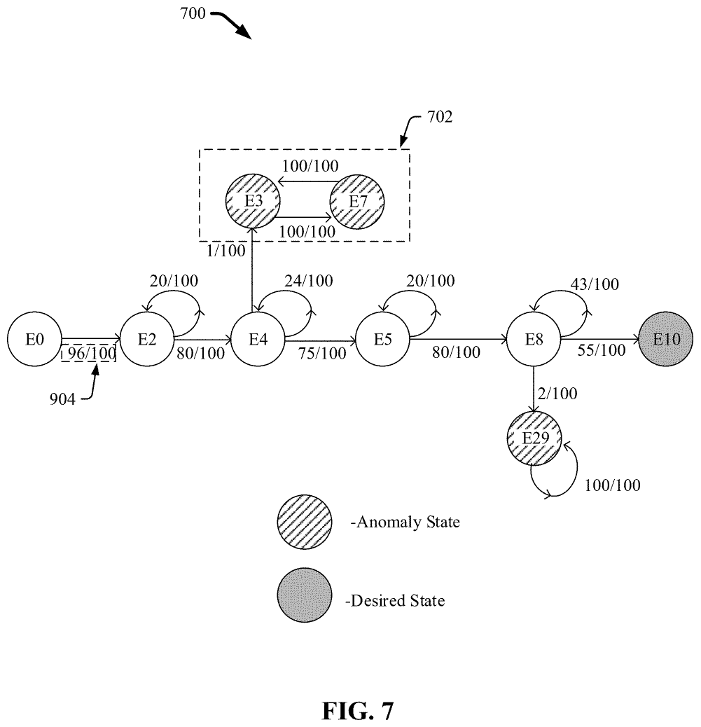

FIG. 7 illustrates an example, non-limiting second exemplary execution graph 700 that can be generated by the execution model component 502 in accordance with one or more embodiments described herein. Repetitive description of like elements employed in other embodiments described herein is omitted for sake of brevity. The second exemplary execution graph 700 can model the example event sequences 402 depicted in FIG. 4. For example, the second exemplary execution graph 700 can aggregate the plurality of example event sequences 402 depicted in FIG. 4 into a single model.

As shown in FIG. 7, the example event sequences 402 shown in FIG. 4 can have multiple event transitions in common. Thus, the second exemplary execution graph 700 can model the example event sequences 402 via a main branch of interconnected nodes 602 with two diverging branches extending from the main branch. Further, each branch end (e.g., ends of the diverging branches and/or the main branch) can be defined by the execution model component 502 as an anomaly state or a desired state. For example, the transition between the node 602 representing E3 from the second exemplary log mining template 202b and the node 602 representing E7 from the second exemplary log mining template 202b and vice versa can repeat in a closed loop 702. Thus, the closed loop 702 can be delineated as an anomaly state of the computer application 108 at least because entering the closed loop 702 prohibits the computer application 108 from executed the assigned job and/or resource. Likewise, a transition to the node 602 representing E29 from the second exemplary log mining template 202b can result in an anomaly state at least because the computer application 108 would continuously repeat E29. In contrast, transitioning to the node 602 representing E10 can achieve a desired state, as E10 can delineate the completion of a job (e.g., as described in the second exemplary log mining template 202b, shown in FIG. 4).

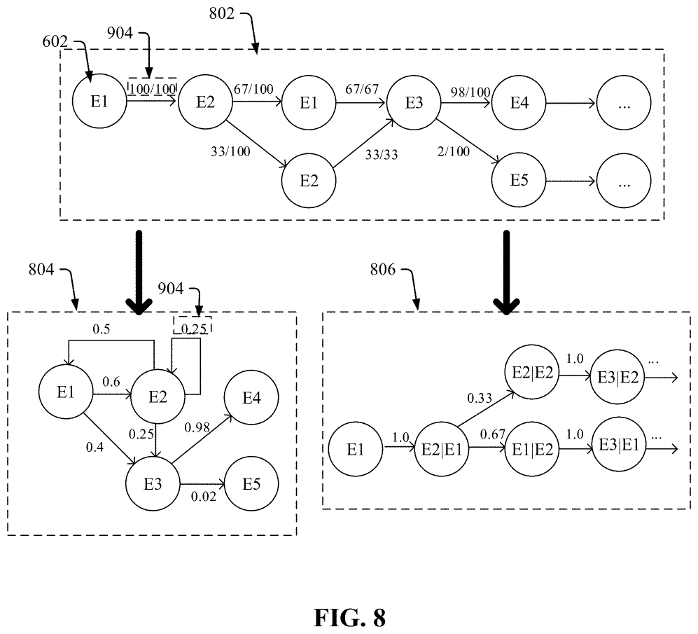

FIG. 8 illustrates example, non-limiting execution graph formats that can be employed by the execution model component 502 in accordance with one or more embodiments described herein. Repetitive description of like elements employed in other embodiments described herein is omitted for sake of brevity. In various embodiments, the execution model component 502 can generate the one or more execution graphs via a variety of formats. For example, FIG. 8 illustrates three example formats that can be employed by the execution model component 502 to model the same one or more event sequences. For instance, the first exemplary execution graph format 802, the second exemplary execution graph format 804, and/or the third exemplary execution graph format 806 can model the same one or more event sequences.

As exemplified in the first exemplary execution graph format 802, an execution graph generated by the execution model component 502 can model the recurrence of one or more events 306 via multiple nodes 602 representing a category from the one or more log mining templates 202. For instance, the first exemplary execution graph format 802 can include two nodes 602 representing E1 (e.g., a respective node 602 for each occurrence of E1 within the modeled event sequence) and two nodes 602 representing E2 (e.g., a respective node 602 for each occurrence of E2 within the modeled event sequence). As exemplified in the second exemplary execution graph format 804, the same event sequence can be modeled by the execution model component 502 by a Markov chain that includes single nodes 602 for E1 and E2, respectively. As exemplified in the third exemplary execution graph format 806, the same event sequence modeled by the first exemplary execution graph format 802 and/or the second execution graph format 804 can be modeled by another Markov chain format. Within the third exemplary execution graph format 806, one or more of the nodes 602 can represent a particular transition from one category to another category (e.g., from one event 306 to another event 306). For instance, the node 602 labelled “E2|E1” shown in FIG. 8 can represent a transition to E2 from E1. Likewise the node 602 labelled “E2|E2” shown in FIG. 8 can represent a transition from E2 to E2 (e.g., as equivalently modeled in the first exemplary execution graph format 802 and/or the second execution graph format 804).

In various embodiments, the execution model component 502 can employ multiple formats to model the one or more event sequences. In one or more embodiments, the one or more input devices 106 can be employed to define the one or more graph formats utilized by the execution model component 502. Further, the execution model component 502 can employ one or more additional formats not exemplified in FIG. 8. One of ordinary skill in the art will recognize that a variety of graphing formats can be utilized by the execution model component 502.

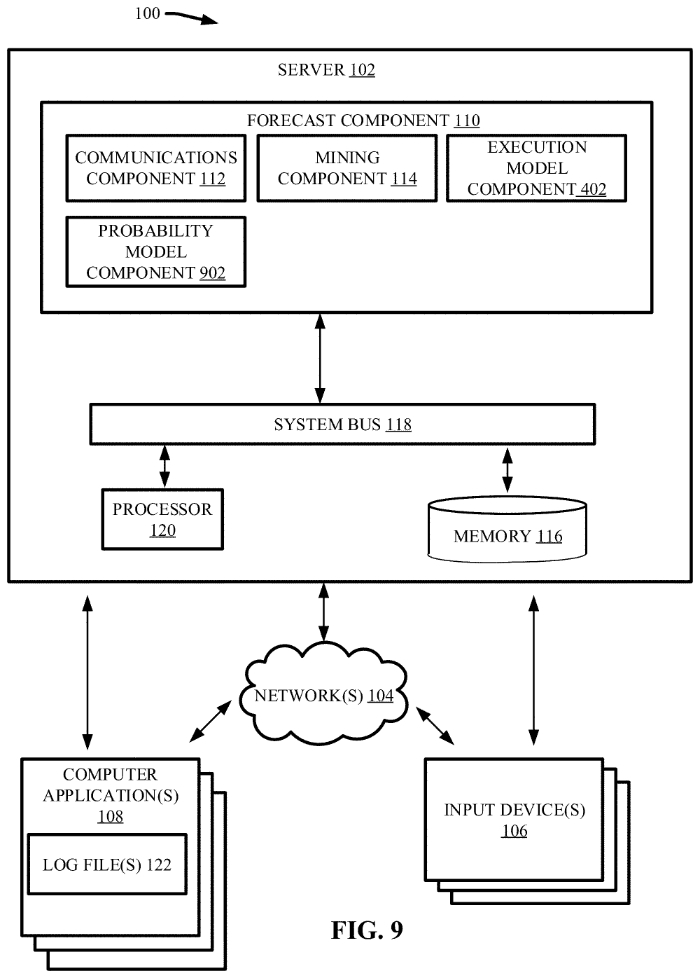

FIG. 9 illustrates a diagram of the example, non-limiting system 100 further comprising probability model component 902 in accordance with one or more embodiments described herein. Repetitive description of like elements employed in other embodiments described herein is omitted for sake of brevity. In various embodiments, the probability model component 902 can determine a likelihood associated with each transition between nodes 602 included in the one or more execution graphs generated by the execution model component 502 based on the one or more log files 122.

In one or more embodiments, the probability model component 902 can determine one or more probability values 904 (e.g., as shown in FIGS. 6-8) associated with each transition modeled by the one or more execution graphs. Referring again to FIGS. 6-8, the one or more probability values 904 can be incorporated into the one or more execution graphs next to each node 602 connection representing an event transition characterized by the respective probability value 904. For example, the one or more probability values 904 can define a probability that the computer application 108 will transition from one node 602 in the execution graph to another, interconnected node 602. For instance, in the first exemplary execution graph 600 (e.g., shown in FIG. 6), a probability value 904 of “1/100” can describe a 1 percent likelihood of the computer application 108 transitioning from E0 to E1. In another instance, in the second exemplary execution graph 700 (e.g., shown in FIG. 7), a probability value 904 of “96/100” can describe a 96 percent likelihood of the computer application 108 transitioning from E0 to E2. As shown in FIG. 8, the format of the probability value 904 can change, and/or the value of the probability value 904 can change, based on the formatting of the one or more execution graphs.

In various embodiments, the probability model component 902 can determine the one or more probability values 904 based on the one or more log files 122. For example, the one or more probability values 904 can define the number of times a given event transition occurred within the one or more log files 122 out of a total number of possible occurrences. For instance, the probability value 904 of 96/100 associated with the event transition from E0 to E2 shown in FIG. 7 can delineate that out of 100 instances in which the computer application 108 experienced the event 306 represented by E0 (e.g., as described in the one or more log files 122), the computer application 108 then transitioned from E0 to the event 306 represented by E2 96 times. In other words, once the computer application 108 experiences the event 306 associated with E0, the computer application 108 is highly likely to subsequently experience the event 306 associated with E2 (e.g., and/or the state associated with E2).

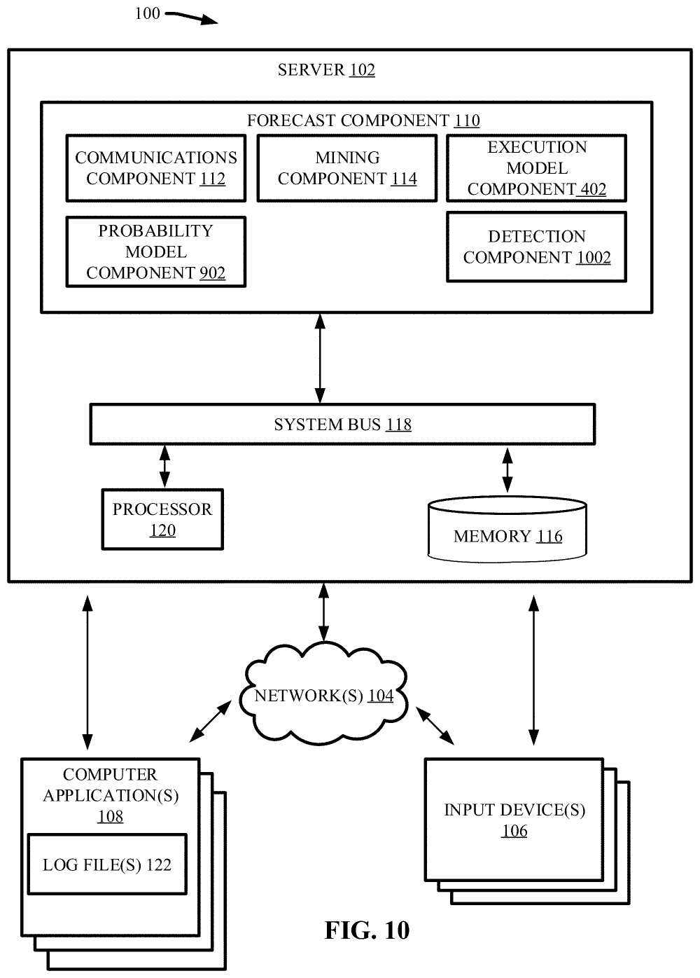

FIG. 10 illustrates a diagram of the example, non-limiting system 100 further comprising detection component 1002 in accordance with one or more embodiments described herein. Repetitive description of like elements employed in other embodiments described herein is omitted for sake of brevity. In various embodiments, the detection component 1002 can determine the current state of a computer application 108 and determine the likelihood that the current execution of the computer application 108 will progress to an anomaly state based on the one or more execution graphs and/or probability values 904.

In one or more embodiments, detection component 1002 can detect where a running computer application 108 is currently positioned on the one or more execution graphs based on one or more newly recorded log files 122. For example, as the computer application 108 is running, the computer application 108 can generate new log data describing its current state during execution. The new log data can be included in one or more log files 122, shared with the forecast component 110, and analyzed by the detection component 1002. For instance, the one or more computer applications 108 can stream log files 122 describing the most recent activity of the computer application 108 to the forecast component 110 via the one or more networks 104. In various embodiments, the detection component 1002 can compare the latest log data of the new log files 122 to the one or more execution graphs generated by the execution model component 502. Where the detection component 1002 can match the event 306 and/or event sequence described by the latest log data to the nodes 602 and/or sequence of nodes 602 in the one or more execution graphs, the detection component 1002 can determine that the running computer application 108 is currently positioned at the matched section of the one or more execution graphs.

Once the detection component 1002 determines the running computer application's 108 current position on the one or more execution graphs, the detection component 1002 can determine a probability that the current execution of the running computer application 108 will progress towards an anomaly state and/or a probability that the current execution will achieve an anomaly state. In various embodiments, the detection component 1002 can determine the probabilities, and/or predict the occurrence of an anomaly state, based on the one or more probability values 904 generated by the probability model component 902. For example, the detection component 1002 can identify one or more paths along the execution graph that model a progression of the running computer application 108 from the current position to one or more anomaly states. For instance, the one or more identified paths can comprise a series of transitions between nodes 602 of the one or more execution graphs that result in the computer application 108 achieving an anomaly state. By analyzing the one or more probability values 904 associated with the one or more transition along the one or more identified paths, the detection component 1002 can determine the probability of the computer application 108 progressing towards, and/or achieving, an anomaly state. For example, the detection component 1002 can aggregate the probability values 904 associated with a given path of the execution graph to determine a probability that the computer application 108 will progress to a point along the path and/or progress to the end of the path. Additionally, in one or more embodiments, the detection component 1002 can employ the same techniques to determine the probability of the running computer application 108 achieving one or more desired states.

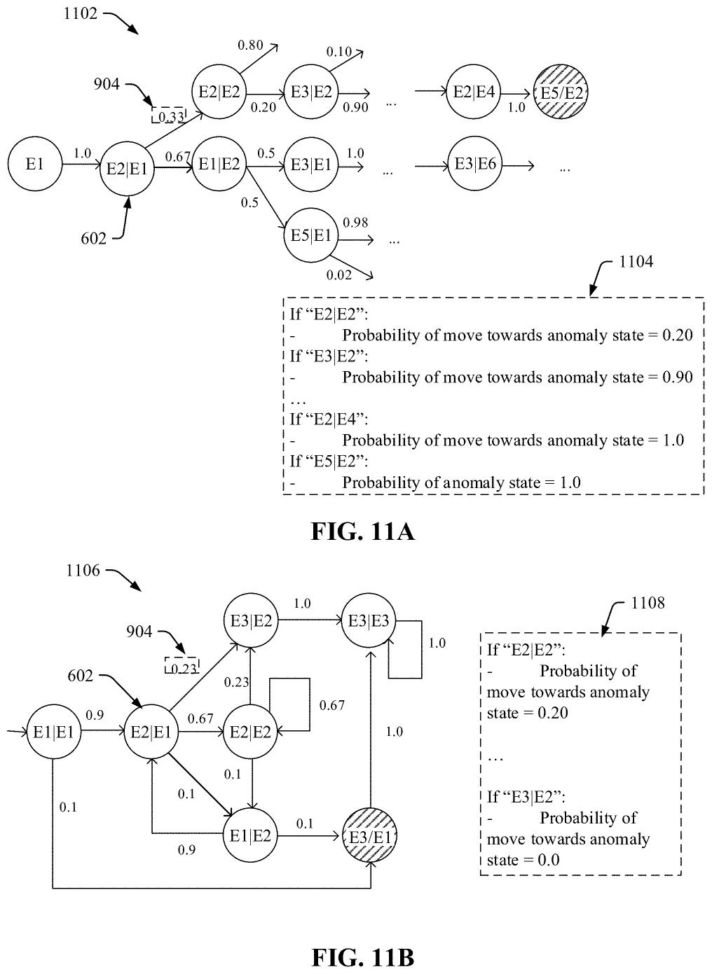

FIGS. 11A-B illustrate diagrams of example, non-limiting probability determinations that can be generated by the detection component 1002 in accordance with one or more embodiments described herein. Repetitive description of like elements employed in other embodiments described herein is omitted for sake of brevity. FIG. 11A depicts a third exemplary execution graph 1102 that can be generated by the execution model component 502. As shown in FIG. 11A, the third exemplary execution graph 1102 can further be populated with one or more probability values 904 generated by the probability model component 902. Also, shown in FIG. 11A is one or more first exemplary probability determinations 1104 that can be generated by the detection component 1002 based on the third exemplary execution graph 1102 in accordance with one or more embodiments described herein. FIG. 11A exemplifies that the detection component 1002 can determine a probability of the running computer application 108 progressing towards, and/or achieving, an anomaly state based on the computer application's 108 position on the execution graph, the possible event sequences historically experienced by the computer application 108 (e.g., as described in the one or more log files 122), and/or the probability values 904. For instance, if the running computer application 108 is currently at a state correlating to the node 602 representing E2|E2 on the third exemplary execution graph 1102, the detection component 1002 can determine that the computer application 108 has a 0.20 probability of progressing towards an anomaly state during the given execution.

FIG. 11B depicts a fourth exemplary execution graph 1106 that can be generated by the execution model component 502. As shown in FIG. 11B, the fourth exemplary execution graph 1106 can further be populated with one or more probability values 904 generated by the probability model component 902. Also, shown in FIG. 11B is one or more second exemplary probability determinations 1108 that can be generated by the detection component 1002 based on the fourth exemplary execution graph 1106 in accordance with one or more embodiments described herein. FIG. 11B further exemplifies that the detection component 1002 can determine a probability of the running computer application 108 progressing towards, and/or achieving, an anomaly state based on the computer application's 108 position on the execution graph, the possible event sequences historically experienced by the computer application 108 (e.g., as described in the one or more log files 122), and/or the probability values 904. For instance, if the running computer application 108 is currently at a state correlating to the node 602 representing E3|E2 on the fourth exemplary execution graph 1106, the detection component 1002 can determine that the computer application 108 has a zero probability of progressing towards an anomaly state during the given execution.

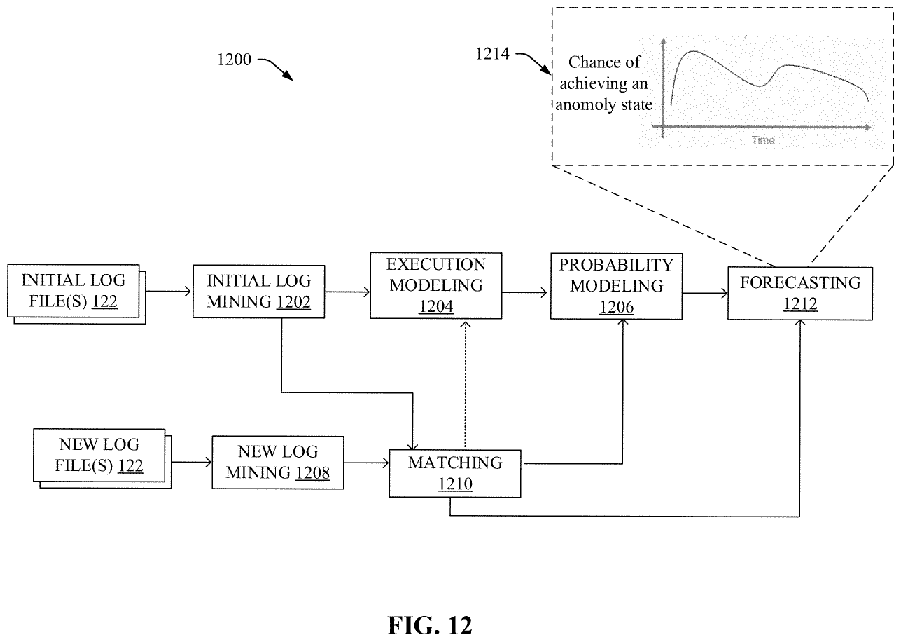

FIG. 12 illustrates a diagram of an example, non-limiting operating scheme 1200 that can be employed by the system 100 in accordance with one or more embodiments described herein. Repetitive description of like elements employed in other embodiments described herein is omitted for sake of brevity. As shown in FIG. 12, the operating scheme 1200 can include generating and/or updating the one or more log mining templates 202, execution graphs, and/or probability values 904 described herein while a computer application 108 is running to forecast one or more future states of the computer application 108.

The operating scheme 1200 can include an initial log mining 1202 (e.g., via the mining component 114) of one or more initial log files 122, which can describe past executions performed by the one or more computer applications 108. In accordance with various embodiments described herein, the mining component 114 can perform the initial log mining 1202 using one or more log mining techniques to generate templates (e.g., log mining templates 202) and/or event sequences (e.g., as exemplified with regards to FIGS. 2-4).

Further, the operating scheme 1200 can include execution modeling 1204 (e.g., via the execution model component 502) that can model the one or more event sequences derived from the log data. In accordance with various embodiments described herein, the execution model component 502 can perform the execution modeling 1204 by generating one or more execution graphs (e.g., as exemplified with regards to FIGS. 6-8). Additionally, the operating scheme 1200 can include probability modeling 1206 (e.g., via the probability model component 902) that can model the probability of transitioning from one node 602 to another node 602 within the one or more execution graphs. In accordance with various embodiments described herein, the probability model component 902 can generate one or more probability values 904 based on the log data to characterize the chance of the computer application 108 experiencing a given node 602 transition based on the historic occurrences of the given node 602 transition within the log data.

As described herein, the one or more computer applications 108 can generate new log files 122 while performing one or more new and/or current executions. The operating scheme 1200 can analyze and/or incorporate the log data of the new log files 122 into the execution modeling 1204 and/or probability modeling 1206. For example, the operating scheme 1200 can include a new log mining 1208 (e.g., via mining component 114) of one or more new log files 122, which can describe new executions performed by the one or more computer applications 108. Further, the operating scheme 1200 can comprise matching 1210 the new log data with the templates and/or event sequences previously generated based on the initial log files 122. For example, the mining component 114 can compare the new log data with the previously generated templates and/or event sequences. Where the new log data describes a new event sequence (e.g., an event sequence not previously modeled the execution modeling 1204), the new log data can be shared with the execution model component 502 to update the execution modeling 1204. For example, the one or more previously generated execution graphs can be amended to incorporate the one or more new event sequences derived from the new log files 122.

Additionally, the matching 1210 can enable an update to the probability modeling 1206. For example, the new log data can be shared with the probability model component 902 to update the one or more probability values 904. For instance, the one or more probability values 904 can be a function of the number time the computer application 108 has experienced a given node 602 transition in the past. Thus, the absence and/or presence of the given node 602 transition within the executions described by the new log files 122 can be reflected in the updated probability values 904.

The operating scheme 1200 can further include forecasting 1212 future states of the running computer application 108 based on the execution modeling 1204 (e.g., updated based on the new log files 122) and/or probability modeling 1206 (e.g., updated based on the new log files 122). In accordance with various embodiments described herein, the detection component 1002 can map the running computer application 108 to the one or more execution graphs based on the matching 1210. Further, the detection component 1002 can identify the paths of progression through the execution graphs available to the computer application 108 based on the computer application's 108 current position on the one or more execution graph. Each path through the one or more execution graphs can end in an anomaly state or a desired state. For each path, the detection component 1002 can aggregate the associate probability values 904 to determine the chances of the computer application 108 progressing towards, and/or achieving, the path's given end state. In one or more embodiments, the detection component 1002 can further generate a probability graph 1214, which can model how the computer application's 108 chance of achieving a given future state changes over time. For example, as time passes during an execution performed by the computer application 108, the computer application 108 can progress through the one or more execution graphs (e.g., as described by the new log files 122 generated during the execution). As the computer application 108 progresses through the one or more execution graphs, an aggregation of the probability values 904 can change, as compared to the probability value 904 aggregation associated with another position in the one or more execution graphs.

Operating scheme 1200 exemplifies how the modeling generated by the forecast component 110 can evolve as the one or more computer applications 108 are running, and new log files 122 become available for analysis. In various embodiments, the one or more new log files 122 can be generated by running computer applications 108 other than the computer application 108 subject to a given forecasting. As such, the forecasting for a given computer application 108 can incorporate lessons learned from past experiences of another computer application 108. Additionally, in accordance with the various embodiments described herein, the forecast component 110 models both desired execution behaviors (e.g., behaviors resulting in a desired state) and undesired execution behaviors (e.g., behaviors resulting in an anomaly state); thereby, negating typical anomaly detection requirements of supervised learning to generate models of solely desired behaviors. In various embodiments, the outputs of the forecast component 110 and the associate components of the forecast component 110 (e.g., including, log mining templates 202, event sequences, execution graphs, probability values, probability graphs, and/or the like) can be displayed via the one or more input devices 106.

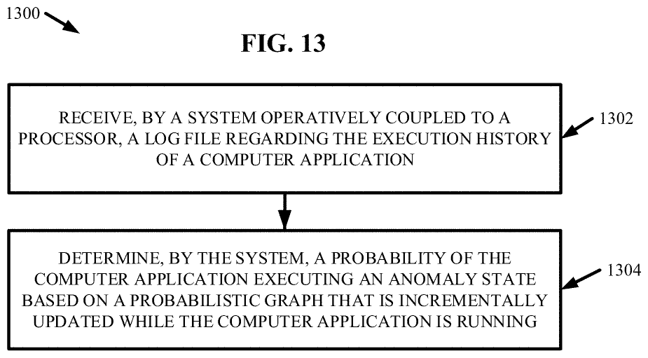

FIG. 13 illustrates a flow diagram of an example, non-limiting method 1300 that can be implemented by the system 100 to forecast anomaly states of a running computer application 108 in accordance with one or more embodiments described herein. Repetitive description of like elements employed in other embodiments described herein is omitted for sake of brevity.

At 1302, the method 1300 can comprise receiving (e.g., via communication component 112), by a system 100 operatively coupled to a processor 120, one or more log files 122 regarding the execution history of one or more computer applications 108. In accordance with various embodiments described herein, the one or more log files 122 can describe both: past executions of the one or more computer application 108 that achieved a desirable state, and past executions of the one or more computer applications 108 that achieved an anomaly state. Further, in various embodiments, the log data included in the one or more log files 122 can be standardized (e.g., via mining component 114) by one or more log mining techniques in accordance with one or more templates.

At 1304, the method 1300 can comprise determining (e.g., via forecast component 110), by the system 100, a probability of the one or more computer applications 108 executing an anomaly state based on one or more probabilistic graphs that can be incrementally updated while the one or more computer applications 108 are running. For example, the execution model component 502 and/or the probability model component 902 can generate the one or more probabilistic graphs embodied as the one or more execution graphs described herein, which can include probability values 904 characterizing the likelihood of the one or more computer applications 108 transitioning from one event to another based on past executions. As exemplified by the operating scheme 1200, the forecast component 110 can incrementally update the one or more probabilistic graphs as new log data is generated by the one or more running computer applications 108. For example, the one or more probabilistic graphs can be updated to reflect the event sequences and/or event frequencies delineated by log files 122 recently generated by the one or more computer application 108 while executing a job. Thereby, the one or more probabilistic graphs can evolve while the one or more computer applications 108 are running, and/or while an anomaly forecasting is being performed by the forecast component 110.

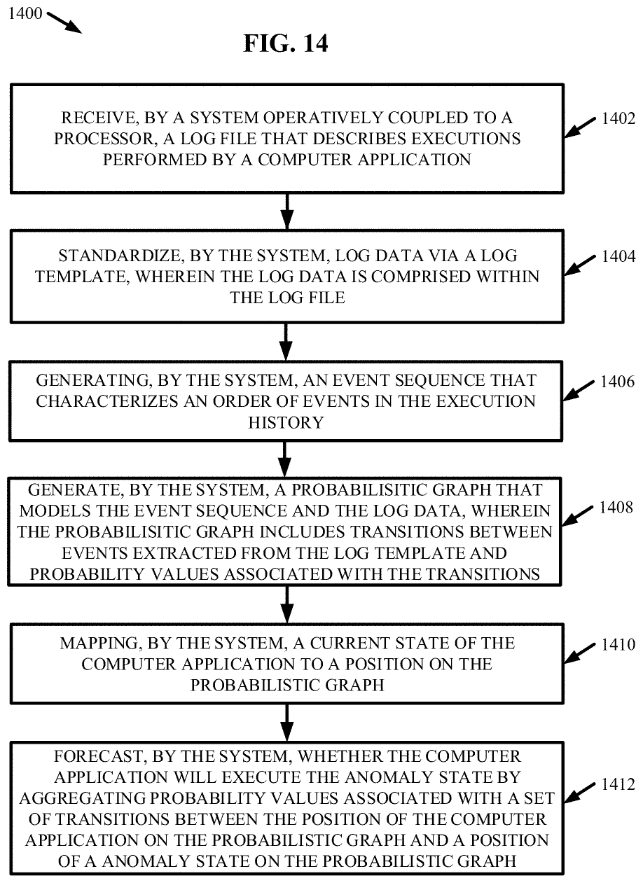

FIG. 14 illustrates a flow diagram of an example, non-limiting method 1400 that can be implemented by the system 100 to forecast anomaly states of a running computer application 108 in accordance with one or more embodiments described herein. Repetitive description of like elements employed in other embodiments described herein is omitted for sake of brevity.

At 1402, the method 1400 can comprise receiving (e.g., via communication component 112), by a system 100 operatively coupled to a processor 120, one or more log files 122 regarding the execution history of one or more computer applications 108. In accordance with various embodiments described herein, the one or more log files 122 can describe both: past executions of the one or more computer application 108 that achieved a desirable state, and past executions of the one or more computer applications 108 that achieved an anomaly state. Further, in various embodiments, the log data included in the one or more log files 122 can be standardized (e.g., via mining component 114) by one or more log mining techniques in accordance with one or more templates.

At 1404, the method 1400 can comprise standardizing (e.g., via mining component 114), by the system 100, log data via one or more log templates (e.g., as exemplified via log mining template 202), wherein the log data can be comprised within the one or more log files 122. For example, the mining component 114 can generate one or more templates to format the log data into one or more uniform structures in accordance with various embodiments described herein. At 1406, the method 1400 can comprise generating (e.g., via mining component 114), by the system 100, one or more event sequences that can characterize an order of events 306 in the execution history. For example, the one or more event sequences can describe one or more events 306 experienced by the one or more computer applications 108 in the order in which the computer applications 108 experienced the events 306 (e.g., chronological order).

At 1408, the method 1400 can comprise generating (e.g., via execution model component 502 and/or probability model component 902), by the system 100, one or more probabilistic graphs that can model the one or more event sequences and/or log data. Further, the one or more probabilistic graphs can include one or more transitions between the events 306 extracted from the one or more log templates (e.g., exemplified by log mining template 202) and/or probability values 904 associated with the one or more transitions. For example, the one or more probabilistic graphs can be exemplified by the execution graphs described herein (e.g., as illustrated in at least FIGS. 6-8 and 11). For instance, transitions between events 306 can be modeled in the one or more probabilistic graphs via connections between one or more nodes 602.

At 1410, the method 1400 can comprise mapping (e.g., via detection component 1002), by the system 100, a current state of the one or more computer applications 108 to a position on the one or more probabilistic graphs. For example, as the one or more computer applications 108 can generate additional log data while running. The detection component 1002 can match the one or more events and/or event sequences of the additional log data to events and/or event sequences modeled in the one or more probabilistic graphs (e.g., execution graphs). At 1412, the method 1400 can comprise forecasting (e.g., via detection component 1002), by the system 100, whether the one or more computer applications 108 will execute an anomaly state by aggregating probability values 904 associated with a set of transitions between the position of the one or more computer applications 108 on the one or more probabilistic graphs and a position of one or more anomaly state on the one or more probabilistic graphs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

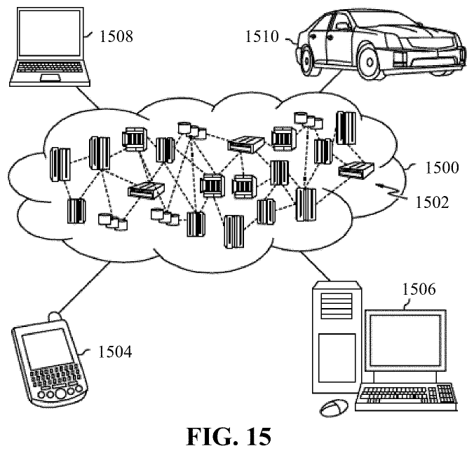

Referring now to FIG. 15, illustrative cloud computing environment 1500 is depicted. As shown, cloud computing environment 1500 includes one or more cloud computing nodes 1502 with which local computing devices used by cloud consumers, such as, for example, personal digital assistant (PDA) or cellular telephone 1504, desktop computer 1506, laptop computer 1508, and/or automobile computer system 1510 may communicate. Nodes 1502 may communicate with one another. They may be grouped (not shown) physically or virtually, in one or more networks, such as Private, Community, Public, or Hybrid clouds as described hereinabove, or a combination thereof. This allows cloud computing environment 1500 to offer infrastructure, platforms and/or software as services for which a cloud consumer does not need to maintain resources on a local computing device. It is understood that the types of computing devices 1504-1510 shown in FIG. 15 are intended to be illustrative only and that computing nodes 1502 and cloud computing environment 1500 can communicate with any type of computerized device over any type of network and/or network addressable connection (e.g., using a web browser).

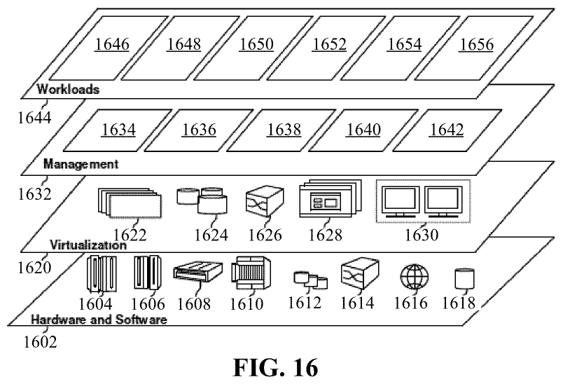

Referring now to FIG. 16, a set of functional abstraction layers provided by cloud computing environment 1500 (FIG. 15) is shown. Repetitive description of like elements employed in other embodiments described herein is omitted for sake of brevity. It should be understood in advance that the components, layers, and functions shown in FIG. 16 are intended to be illustrative only and embodiments of the invention are not limited thereto. As depicted, the following layers and corresponding functions are provided.

Hardware and software layer 1602 includes hardware and software components. Examples of hardware components include: mainframes 1604; RISC (Reduced Instruction Set Computer) architecture based servers 1606; servers 1608; blade servers 1610; storage devices 1612; and networks and networking components 1614. In some embodiments, software components include network application server software 1616 and database software 1618.

Virtualization layer 1620 provides an abstraction layer from which the following examples of virtual entities may be provided: virtual servers 1622; virtual storage 1624; virtual networks 1626, including virtual private networks; virtual applications and operating systems 1628; and virtual clients 1630.

In one example, management layer 1632 may provide the functions described below. Resource provisioning 1634 provides dynamic procurement of computing resources and other resources that are utilized to perform tasks within the cloud computing environment. Metering and Pricing 1636 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1638 provides access to the cloud computing environment for consumers and system administrators. Service level management 1640 provides cloud computing resource allocation and management such that required service levels are met. Service Level Agreement (SLA) planning and fulfillment 1642 provide pre-arrangement for, and procurement of, cloud computing resources for which a future requirement is anticipated in accordance with an SLA.

Workloads layer 1644 provides examples of functionality for which the cloud computing environment may be utilized. Examples of workloads and functions which may be provided from this layer include: mapping and navigation 1646; software development and lifecycle management 1648; virtual classroom education delivery 1650; data analytics processing 1652; transaction processing 1654; and anomaly forecasting 1656. For example, various embodiments of the present invention can utilize the cloud computing environment described with reference to FIGS. 15 and 16 to: share log files 122 amongst the various components of the system 100, generate one or more probabilistic graphs, and/or incrementally update one or more probabilistic graphs.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

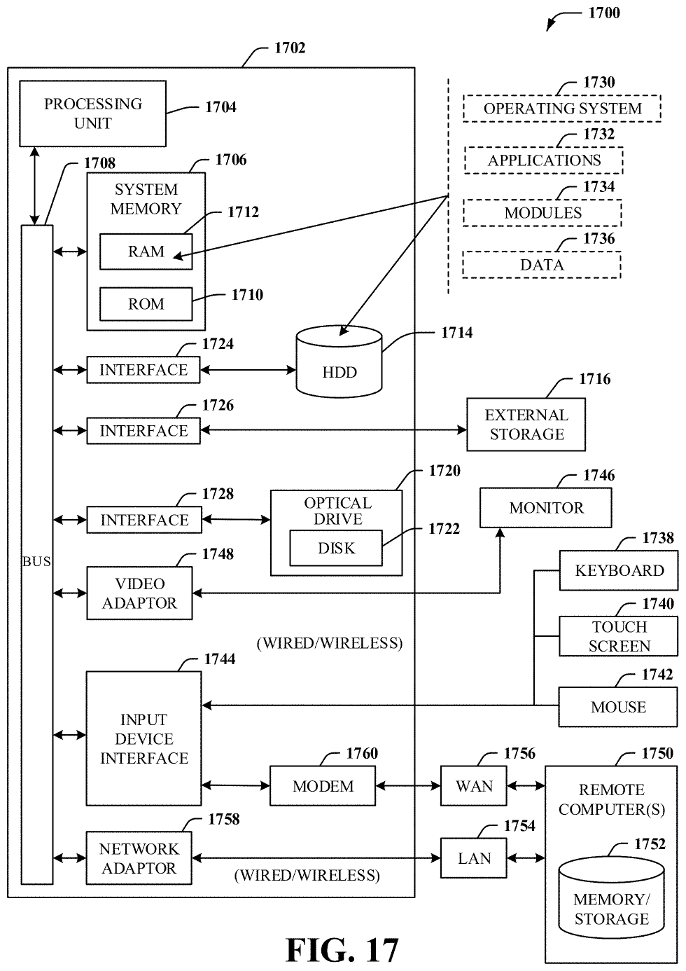

In order to provide additional context for various embodiments described herein, FIG. 17 and the following discussion are intended to provide a general description of a suitable computing environment 1700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, and/or the like, that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (“IoT”) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (“RAM”), read only memory (“ROM”), electrically erasable programmable read only memory (“EEPROM”), flash memory or other memory technology, compact disk read only memory (“CD-ROM”), digital versatile disk (“DVD”), Blu-ray disc (“BD”) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (“BIOS”) can be stored in a non-volatile memory such as ROM, erasable programmable read only memory (“EPROM”), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (“HDD”) 1714 (e.g., EIDE, SATA), one or more external storage devices 1716 (e.g., a magnetic floppy disk drive (“FDD”) 1716, a memory stick or flash drive reader, a memory card reader, a combination thereof, and/or the like) and an optical disk drive 1720 (e.g., which can read or write from a CD-ROM disc, a DVD, a BD, and/or the like). While the internal HDD 1714 is illustrated as located within the computer 1702, the internal HDD 1714 can also be configured for external use in a suitable chassis (not shown). Additionally, while not shown in environment 1700, a solid state drive (“SSD”) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (“USB”) and Institute of Electrical and Electronics Engineers (“IEEE”) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (“VM”) of multiple VMs hosted at computer 1702. Furthermore, operating system 1730 can provide runtime environments, such as the Java runtime environment or the .NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can be enable with a security module, such as a trusted processing module (“TPM”). For instance with a TPM, boot components hash next in time boot components, and wait for a match of results to secured values, before loading a next boot component. This process can take place at any layer in the code execution stack of computer 1702, e.g., applied at the application execution level or at the operating system (“OS”) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (“IR”) remote control, a radio frequency (“RF”) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, and/or the like.

A monitor 1746 or other type of display device can be also connected to the system bus 1708 via an interface, such as a video adapter 1748. In addition to the monitor 1746, a computer typically includes other peripheral output devices (not shown), such as speakers, printers, a combination thereof, and/or the like.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (“LAN”) 1754 and/or larger networks, e.g., a wide area network (“WAN”) 1756. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (“AP”) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the Internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are example and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756 e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, and/or the like), and telephone. This can include Wireless Fidelity (“Wi-Fi”) and BLUETOOTH® wireless technologies. Thus, the communication can be a predefined structure as with a conventional network or simply an ad hoc communication between at least two devices.

What has been described above include mere examples of systems, computer program products and methods. It is, of course, not possible to describe every conceivable combination of components, products and/or methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor, operably coupled to the memory, and that executes the computer executable components stored in the memory, wherein the computer executable components comprise:
a forecast component that determines a probability of a computer application executing an anomaly state based on a probabilistic graph that is incrementally updated while the computer application is running.

2. The system of claim 1, further comprising:
a mining component that standardizes log data via a log template, wherein the log data is comprised within a log file that describes a past execution performed by the computer application, and the mining component further generates an event sequence that characterizes an order of events in the past execution.

3. The system of claim 2, wherein the mining component incrementally updates the probabilistic graph by mining additional log data from an additional log file that describes a more recent execution performed by the computer application than the past execution.

4. The system of claim 2, further comprising:
an execution model component that generates the probabilistic graph that models the event sequence and the log data, wherein the probabilistic graph includes transitions between events extracted from the log template and probability values associated with the transitions.

5. The system of claim 4, wherein the probabilistic graph is a type selected from the group consisting of a Markov chain, a probabilistic tree, Bayesian network, and Markov Random fields.

6. The system of claim 5, further comprising:
a probability model component that determines a probability that a last event delineated by the event sequence will be executed by the computer application by aggregating the probability values associated with the transitions.

7. The system of claim 5, wherein the mining component generates a plurality of event sequences based on the log file, wherein the probabilistic graph models the plurality of event sequences, wherein a first event sequence from the plurality of event sequences modeled by the probabilistic graph characterizes a first order of events that achieves the anomaly state, and wherein a second order of events from the plurality of event sequences modeled by the probabilistic graph characterizes a second order of events that achieves a desired state.

8. The system of claim 6, further comprising:
a detection component that maps a current state of the computer application to a position on the probabilistic graph model.

9. The system of claim 8, wherein the detection component forecasts whether the computer application will execute the anomaly state by aggregating probability values associated with a set of transitions between the position of the computer application on the probabilistic graph and a position of the anomaly state on the probabilistic graph, and wherein the last event is associated with the anomaly state.

10. A computer-implemented method, comprising:
determining, by a system operatively coupled to a processor, a probability of a computer application executing an anomaly state based on a probabilistic graph that is incrementally updated while the computer application is running.

11. The computer-implemented method of claim 10, further comprising:
standardizing, by the system, log data via a log template, wherein the log data is comprised within a log file that describes a past execution performed by the computer application; and
generating, by the system, an event sequence that characterizes an order of events in the past execution.

12. The computer-implemented method of claim 11, wherein the probabilistic graph is incrementally updated by mining additional log data from an additional log file that describes a more recent execution performed by the computer application than the past execution.

13. The computer-implemented method of claim 11, further comprising:
generating, by the system, the probabilistic graph that models the event sequence and the log data, wherein the probabilistic graph includes transitions between events extracted from the log template and probability values associated with the transitions.

14. The computer-implemented method of claim 13, further comprising:
determining, by the system, a probability that a last event delineated by the event sequence will be executed by the computer application by aggregating the probability values associated with the transitions.

15. The computer-implemented method of claim 13, further comprising:
mapping, by the system, a current state of the computer application to the probabilistic graph; and
forecasting, by the system, whether the computer application will execute the anomaly state by aggregating probability values associated with a set of transitions between the position of the computer application on the probabilistic graph and a position of the anomaly state on the probabilistic graph.

16. A computer program product for dynamically forecasting an anomaly state on a computer application, the computer program product comprising a computer readable storage medium having program instructions embodied therewith, the program instructions executable by a processor to cause the processor to:
determine, by the processor, a probability of the computer application executing the anomaly state based on a probabilistic graph that is incrementally updated while the computer application is running.

17. The computer program product of claim 16, wherein the program instructions further cause the processor to:
standardize, by the processor, log data via a log template, wherein the log data is comprised within a log file that describes a past execution performed by the computer application; and
generate, by the processor, an event sequence that characterizes an order of events in the past execution.

18. The computer program product of claim 17, wherein the probabilistic graph is incrementally updated by mining, by the processor, additional log data from an additional log file that describes a more recent execution performed by the computer application than the past execution.

19. The computer program product of claim 17, wherein the program instructions further cause the processor to:
generate, by the system, the probabilistic graph that models the event sequence and the log data, wherein the probabilistic graph includes transitions between events extracted from the log template and probability values associated with the transitions.

20. The computer program product of claim 16, wherein the program instructions further cause the processor to:
map, by the processor, a current state of the computer application to a position on the probabilistic graph; and
forecast, by the processor, whether the computer application will execute the anomaly state by aggregating the probabilities associated with a set of transitions between the position of the computer application on the probabilistic graph and a position of the anomaly state on the probabilistic graph.
